(19) United States
(12) Patent Application Publication
(10) Pub. No.: US 2013/0122375 A1
(43) Pub. Date: May 16, 2013

(54) POROUS METAL BODY, AND ELECTRODE MATERIAL AND BATTERY BOTH INCORPORATING THE BODY

(71) Applicant: SUMITOMO ELECTRIC INDUSTRIES, LTD., Osaka (JP)

(72) Inventors: Kengo GOTO, Osaka (JP); Akihisa HOSOE, Osaka (JP); Junichi NISHIMURA, Osaka (JP); Kazuki OKUNO, Osaka (JP); Hajime OTA, Osaka (JP); Koutarou KIMURA, Osaka (JP)

(73) Assignee: SUMITOMO ELECTRIC INDUSTRIES, LTD., Osaka (JP)

(21) Appl. No.: 13/648,637

(22) Filed: Oct. 10, 2012

Related U.S. Application Data
(63) Continuation of application No. PCT/JP2012/063006, filed on May 22, 2012.

(30) Foreign Application Priority Data
Jun. 3, 2011 (JP) 2011-124706

(51) Int. Cl. H01M 4/04; H01M 4/80

(52) U.S. Cl. CPC H01M 4/0454; H01M 4/80
USPC 429/242; 205/112

(57) ABSTRACT

The invention offers a porous metal body that has a three-dimensional network structure, that has less reduction in performance during the pressing and compressing steps when an electrode material is produced, and that can be used as an electrode material capable of achieving good electric properties, a method of producing the porous metal body, and an electrode material and a battery both incorporating the foregoing porous metal body. A porous metal body has a skeleton structure that is formed of a metal layer, that has a three-dimensional network structure, and that has an end portion provided with a nearly spherical portion. It is desirable that the metal be aluminum and that the nearly spherical portion have a diameter larger than the outer diameter of the skeleton structure.

### CROSS-REFERENCE TO RELATED APPLICATIONS

The present application is a continuation of International Application No. PCT/JP2012/063006 filed on May 22, 2012, which claims the benefit of priority from Japanese Patent Application No. 2011-124706 filed on Jun. 3, 2011. All of the above-described applications are incorporated herein by reference.

### TECHNICAL FIELD

The present invention relates to a porous metal body that can be suitably used in applications such as a battery electrode and various filters.

### BACKGROUND ART

A porous metal body having a three-dimensional network structure is used in a multitude of applications such as various filters, a catalyst carrier, and a battery electrode. For example, CELMET (registered trademark of Sumitomo Electric Industries, Ltd.), which is made of nickel, is used as an electrode material for batteries, such as a nickel-metal hydride battery and a nickel-cadmium battery. CELMET is a porous metal body having mutually communicating pores and has a feature in that it has a high porosity (90% or more) in comparison with metallic nonwoven fabric and other porous bodies. The high porosity can be achieved through the following process. First, a nickel layer is formed on the surface of the skeleton of a foamed resinous molded body having mutually communicating pores, such as a urethane foam. Then, the foregoing foamed resinous molded body is decomposed by heat treatment. Finally, the nickel is reduction-treated. The formation of the nickel layer is performed first by coating carbon powder or the like on the surface of the skeleton of the foamed resinous molded body to perform conductivity-giving treatment and then by depositing nickel through electroplating.

Aluminum is excellent in electrical conductivity and corrosion resistance and is a low-weight material. For a battery use, for example, as the positive electrode of a lithium ion battery, an electrode is used that is formed by coating an active material such as lithium cobalt oxide on the surface of an aluminum foil. To increase the capacity of the positive electrode, it is conceivable that its surface area is increased by transforming the aluminum into a porous body to fill the interior of the porous aluminum body with an active material. The reason is that when this idea is actualized, even when the thickness of the electrode is increased, the active material can be utilized effectively, so that the utilization factor of the active material per unit area is increased.

As a method of producing a porous aluminum body, Patent Literature 1 describes a method in which a plastic base material having a three-dimensional network structure provided with mutually communicating spaces in its interior is treated by aluminum vapor deposition through the arc ion plating method to form a metal aluminum layer of 2 to 20 μm. Patent Literature 2 states a method of obtaining a porous metal body as described below. First, on the skeleton of a foamed resinous molded body having a three-dimensional network structure, a film is formed which is made of metal, such as copper, that forms a eutectic alloy at the melting point of aluminum or below. Then, aluminum paste is coated on the film to be heat-treated in a non-oxidizing atmosphere at a temperature of 550° C. or more and 750° C. or less. This treatment removes the organic component (the foamed resinous molded body) and performs the sintering of the aluminum powder. Thus, the porous metal body is obtained.

On the other hand, as for the plating of aluminum, it is difficult to conduct electroplating of aluminum in a plating bath belonging to an aqueous solution family because aluminum has a high affinity for oxygen and has an electric potential lower than that of hydrogen. As a consequence, the electroplating of aluminum is conventionally performed in a plating bath belonging to a non-aqueous solution family to carry out studies. For example, as a technique for plating aluminum to prevent the oxidation of the surface of metal or to actualize another purpose, Patent Literature 3 has disclosed an electroplating method of aluminum as described below. This method has a feature in that it uses as the plating bath a low-melting point composite produced by melt-mixing onium halide and aluminum halide and deposits aluminum on the cathode while maintaining the water content in the bath at 2 wt % or below.

### CITATION LIST

### Patent Literature

Patent Literature 1: the published Japanese patent 3413662

Patent Literature 2: the published Japanese patent application Tokukaihei 8-170126

Patent Literature 3: the published Japanese patent 3202072.

### SUMMARY OF INVENTION

### Technical Problem

Patent Literature 1 described above states that a porous aluminum body having a thickness of 2 to 20 μm can be obtained by the method used in the literature. Nevertheless, because this method employs the gas phase method, it is difficult to produce a product having a large area and to form a uniform layer in the interior depending on the thickness of the base material and the porosity. In addition, the method has a problem in that the forming rate of the aluminum layer is low and the production cost is increased owing to the expensive equipment. Furthermore, when a thick film is formed, the film may develop cracks or the aluminum may come off. When the method stated in Patent Literature 2 is employed, a layer forming a eutectic alloy with aluminum is produced, so that an aluminum layer having a high purity cannot be formed. On the other hand, although the electroplating method of aluminum is known, the method can only be applied to the plating on the surface of metal. The electroplating method on the surface of a resinous molded body, particularly on the surface of a porous resinous molded body having a three-dimensional network structure, has not been known. The reason seems to be that a problem such as the dissolution of the porous resin into the plating bath has some influence.

The present inventors have found a method that enables aluminum plating even on the surface of a porous resinous molded body having a three-dimensional network structure and that enables the formation of a highly pure porous aluminum body by forming a thick film uniformly. More specifically, the present inventors have invented a method of producing a porous aluminum body, first, by giving electrical conductivity to the surface of a resinous molded body having a three-dimensional network structure made of polyurethane, melamine resin, or the like and, then, by performing aluminum plating in a molten-salt bath. The present inventors have applied this invention already. The types of the molten salt include a mixture of aluminum chloride and alkali metal salt, a mixture of aluminum chloride and imidazolium salt, and a salt produced by adding an organic solvent to a mixture of aluminum chloride and imidazolium salt. After the aluminum plating is performed by using the above-described molten-salt bath, the resinous molded body is removed. This operation produces a porous aluminum body in which its skeleton structure formed of an aluminum layer has a three-dimensional network structure.

In the porous aluminum body obtained by the above-described method, as shown in FIG. I, the end portion of the skeleton structure has a shape having an edge portion 201, which looks like just being cut off without further treatment. As a result, the end portion of the skeleton structure becomes brittle. When a sheet-shaped porous aluminum body is used as an electrode material, the electrode material is produced through the following process. First, a pressing step adjusts the film thickness by applying pressure from above and below the sheet. Second, an active material is carried by the porous aluminum body by coating a paste produced by mixing an active material, a conductive aid, a binder resin, and the like. Finally, a compressing step compresses the sheet by applying pressure from above and below the sheet. If the end portion of the skeleton structure is brittle, the end portion of the porous aluminum body is broken during the foregoing pressing step or compressing step. In consequence, the current-collecting performance and the active material-retaining performance are degraded. In addition, in the sheet-shaped porous aluminum body, if the end portion is exposed at the surface of the sheet, strength reduction tends to occur during the pressing step. In addition to the foregoing reduction, when used as an electrode material, the edge of the end portion may be brought into contact with a separator, so that the separator may break.

The conventional porous metal body, such as CELMET made of nickel, also has a shape similar to that shown in FIG. 1, and its skeleton structure's end portions have edge portions. Consequently, when the porous metal body is used as an electrode material, a problem similar to that experienced in the case of the porous aluminum body will arise.

In light of the above-described problems, an object of the present invention is to offer a porous metal body that has a three-dimensional network structure, that has less reduction in performance during the pressing and compressing steps when an electrode material is produced, and that can be used as an electrode material capable of achieving good electric properties, a method of producing the porous metal body, and an electrode material and a battery both incorporating the foregoing porous metal body.

### Solution to Problem

The present invention offers a porous metal body having a skeleton structure that is formed of a metal layer, that has a three-dimensional network structure, and that has an end portion provided with a nearly spherical portion. FIG. 2 is a schematic diagram showing the porous aluminum body of the present invention. A skeleton structure 203 having a three-dimensional network structure has end portions provided with nearly spherical portions 202. Because nearly spherical portions 202 are present at the surface, the end portions can be prevented from breaking or the like during a pressing step and a compressing step, so that a porous aluminum body having a high strength can be obtained. In addition, because the skeleton structure has round end portions without having an edge portion, when used as an electrode material, even if it is brought into contact with a separator, damage of the separator is less likely to arise.

It is desirable that the metal material be aluminum. Because aluminum is a material having low weight and excellent conductivity, when the porous aluminum body is used as an electrode material for batteries, good properties can be achieved.

It is desirable that the above-described nearly spherical portion have a diameter larger than the outer diameter of the above-described skeleton structure. When the nearly spherical portion has a large diameter, at the time the active material is carried by the porous metal body, the carried active material gets snagged on the nearly spherical portion, so that the active material is less likely to drop off. The outer diameter of the skeleton structure is defined by the diameter of the cross section at the center portion of the skeleton structure. When the cross section is not a circle, the outer diameter is defined by the diameter of an approximate circle for the cross section. FIG. 3 is a diagram showing an example of the skeleton structure of the porous metal body of the present invention and is the A-A′ cross section shown in FIG. 2. As shown in FIG. 3, the cross section of the skeleton structure is nearly triangular. In this case, a diameter “a” of a circle passing through the three apexes of the triangle is defined as the diameter of the skeleton structure. The symbol “b” denotes the thickness of the metal layer.

As described above, when the skeleton structure has a cross section of a nearly triangular shape, it is desirable that the nearly triangular shape have an outer diameter of 100 μm or more and 250 μm or less and that the metal layer have a thickness of 0.5 μm or more and 10 μm or less. The foregoing numerical range can increase the porosity of the porous metal body.

It is desirable that the porous metal body have the shape of a sheet having a thickness of 1,000 μm or more and 3,000 μm or less and that at the thickness of 1,000 μm, the coating weight (the quantity of the aluminum per unit area) be 120 g/m² or more and 180 g/m² or less. Such a porous aluminum body is suitable for an electrode material for batteries. The use of the above-described porous metal body can produce an electrode material in which the active material is carried by the porous metal body.

A battery, in which the above-described electrode material is used as a positive electrode, a negative electrode, or both, can be obtained. The use of the foregoing electrode material enables an increase in battery capacity.

The present invention also offers a method of producing a porous metal body. The method has a step of plating a resinous molded body, having a three-dimensional network structure in which at least the surface has conductivity, with aluminum in a molten-salt bath that contains 1,10-phenanthroline at a concentration of 0.1 g/l or more and 10 g/l or less and that is held at a temperature of 40° C. or higher and 100° C. or lower. The employing of the foregoing production method enables satisfactory production of a porous metal body whose skeleton structure has end portions provided with nearly spherical portions.

### Advantageous Effects of Invention

The present invention can offer a porous metal body that has a three-dimensional network structure, that has less reduction in performance during the pressing and compressing steps when an electrode material is produced, and that can be used as an electrode material capable of achieving good electric properties, a method of producing the porous metal body, and an electrode material and a battery both incorporating the foregoing porous metal body.

### BRIEF DESCRIPTION OF DRAWINGS

FIG. 1 is an enlarged surface photograph of a conventional porous aluminum body.

FIG. 2 is a schematic diagram showing the porous aluminum body of the present invention.

FIG. 3 is a schematic diagram showing the porous aluminum body of the present invention and is a diagram showing the A-A′ cross section indicated in FIG. 2.

FIG. 4 is a flow chart showing the process of producing the porous aluminum body of the present invention.

FIG. 5 is a schematic cross-sectional diagram illustrating the process of producing the porous aluminum body of the present invention.

FIG. 6 is an enlarged surface photograph showing the structure of a urethane foam as an example of a resinous molded body having a three-dimensional network structure.

FIG. 7 is a diagram illustrating an example of a step of continuously giving conductivity to the surface of a resinous molded body by using conducting paint.

FIG. 8 is a diagram illustrating an example of the continuous aluminum-plating step through the molten-salt plating.

FIG. 9 is a schematic cross-sectional view showing an example of a structure in which a porous aluminum body is applied to a molten-salt battery.

FIG. 10 is a schematic cross-sectional view showing an example of a structure in which a porous aluminum body is applied to an electric double-layer capacitor.

FIG. 11 is an enlarged surface photograph of the porous aluminum body in Example.

FIG. 12 is an enlarged surface photograph of the porous aluminum body in Example.

### DESCRIPTION OF EMBODIMENTS

An explanation is given below to the embodiments of the present invention by using the process of producing a porous aluminum body as the representative example and by referring to the drawing as appropriate. In the drawing referred below, the portion bearing the same number is the same or corresponding portion. The present invention is not limited to the above-described embodiments, is shown by the scope of the claims, and is intended to cover all revisions and modifications included within the meaning and scope equivalent to the scope of the claims.

### Process of Producing Porous Aluminum Body

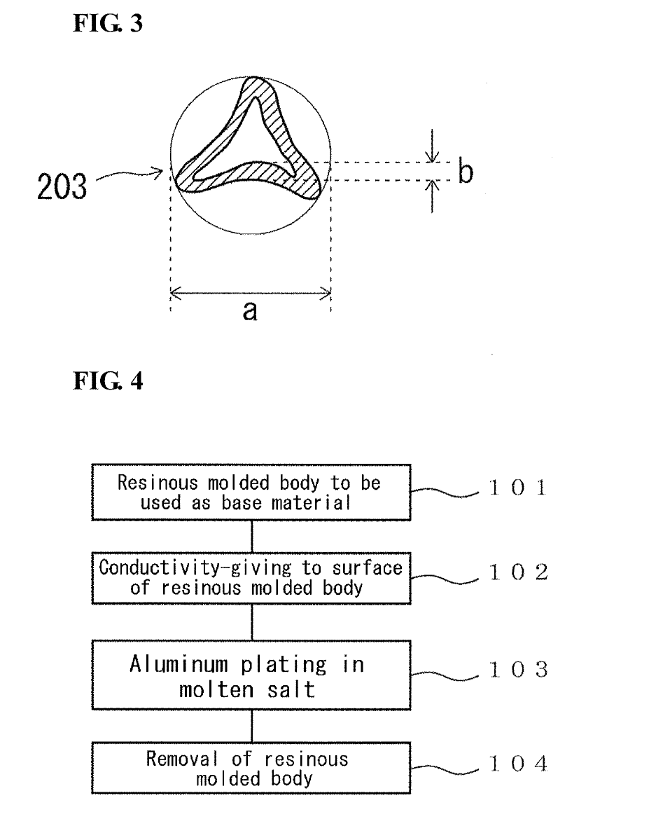

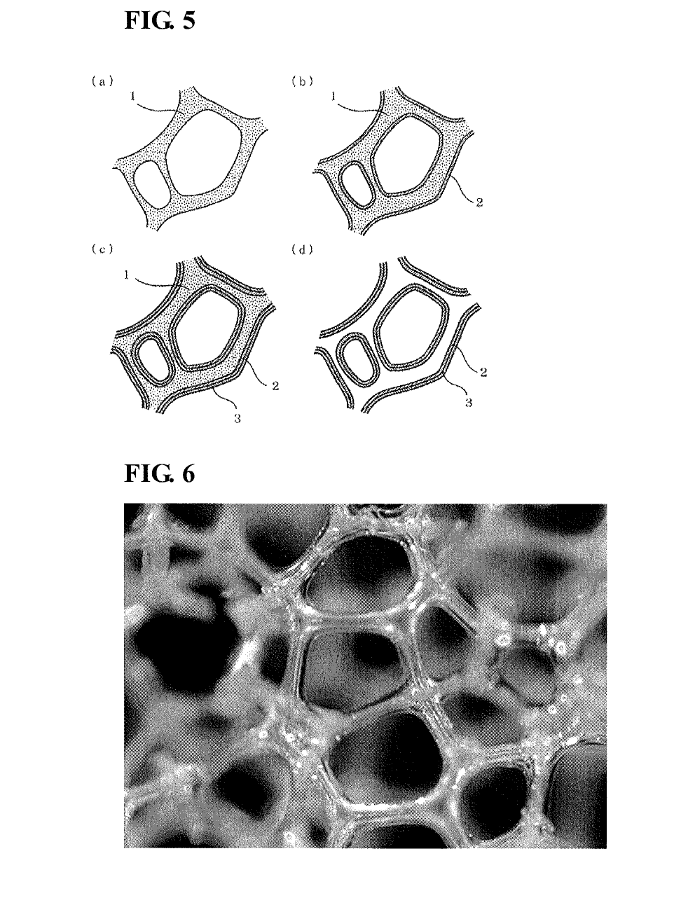

FIG. 4 is a flow chart showing the process of producing the porous aluminum body of the present invention. FIG. 5 schematically shows, in correspondence with the flow chart, the manner of forming the porous aluminum body by using as the core material a resinous molded body having a three-dimensional network structure. The entire flow of the production process is explained below by referring to both Figures. First, a preparation 101 of a resinous molded body to be used as the base material is conducted. FIG. 5 (a) is an enlarged schematic diagram, which shows an enlarged surface of a resinous molded body (a foamed resinous molded body) having a three-dimensional network structure as an example of the resinous molded body to be used as the base material. Pores are formed by using a foamed resinous molded body 1 as the skeleton. Subsequently, a conductivity-giving 102 to the surface of the resinous molded body is performed. As shown in FIG. 5 (b), this step forms a conducting layer 2, having a thin conducting body, on the surface of the resinous molded body 1. Next, an aluminum plating 103 is performed in a molten salt, so that an aluminum plating layer 3 is formed on the surface of the resinous molded body to which the conducting layer has been formed (FIG. 5 (c)). The foregoing process can produce a porous aluminum body in which an aluminum plating layer 3 is formed on the surface of the base material formed of a resinous molded body. In addition, a removal 104 of the resinous molded body as the base material may be performed. The removal of the foamed resinous molded body 1 by decomposing it or otherwise can produce a porous aluminum body in which only metal layer remains (FIG. 5 (d)). The individual steps are explained below in the order of operation.

### Preparation of Resinous Molded Body to be Used as Base Material

A resinous molded body having a three-dimensional network structure is prepared. Any resin may be selected as the material of the resinous molded body. The types of material of the foamed resinous molded body include polyurethane, melamine resin, polypropylene, and polyethylene. It is desirable that the resinous molded body having a three-dimensional network structure have a porosity of 80% to 98% and a pore diameter of 50 to 500 μm. A urethane foam and a melamine foam have high porosity, mutual communicability of pores, and excellent thermal-degradation property. Consequently, they can be used advantageously as the resinous molded body. A urethane foam is desirable in terms of uniformity in pore, availability, and so on, and a melamine foam is desirable because a product having a small pore diameter is available.

A resinous molded body having a three-dimensional network structure often has residuals, such as a foaming agent, unreacted monomers, and the like, in the production step of the foam. For this reason, it is desirable to perform cleaning treatment for the benefit of the subsequent steps. FIG. 6 shows, as an example of the resinous molded body having a three-dimensional network structure, a urethane foam that is cleaning-treated as a pre-treatment. Because the network is structured three-dimensionally by using the resinous molded body as the skeleton, pores continuous as a whole are formed. The skeleton of the urethane foam has a nearly triangular shape in a cross section perpendicular to the extending direction of the skeleton. Here, the porosity is defined by the following equation:

Porosity=(1−(weight of porous material [g]/(volume of porous material [cm³]×density of raw material)))×100[%].

The pore diameter is obtained through the following method. First, the surface of the resinous molded body is enlarged by using a microscope photograph or the like. The number of pores per inch (25.4 mm) is counted as the number of cells. The average value is calculated by using the following equation: average pore diameter=25.4 mm/number of cells.

### Conductivity-Giving to Surface of Resinous Molded Body: Coating of Carbon

Carbon paint is prepared as a conducting paint. It is desirable that a suspension as the conducting paint contain carbon particles, a binder, a dispersant, and a dispersion medium. In order to uniformly coat the conducting particles, the suspension is required to maintain a uniformly suspending condition. To meet this requirement, it is desirable that the suspension be maintained at 20° C. to 40° C. The reason is that if the temperature of the suspension is lower than 20° C., the uniformly suspending condition is not maintained, so that only the binder congregates to form a layer on the surface of the skeleton that forms the network structure of the resinous molded body. If this occurs, the layer of coated carbon particles tends to peel off, so that it is difficult to form a firmly adhering metal plating. On the other hand, if the temperature of the suspension exceeds 40° C., the amount of evaporation of the dispersant is increased, so that as the time of coating treatment elapses, the suspension is concentrated and consequently the amount of coating of carbon tends to fluctuate. The carbon particles have a particle diameter of 0.01 to 5 μm, desirably 0.01 to 0.5 μm. If the particle diameter is large, pores of the resinous molded body may be clogged and smooth plating may be impaired. If excessively small, it is difficult to secure the sufficient conductivity.

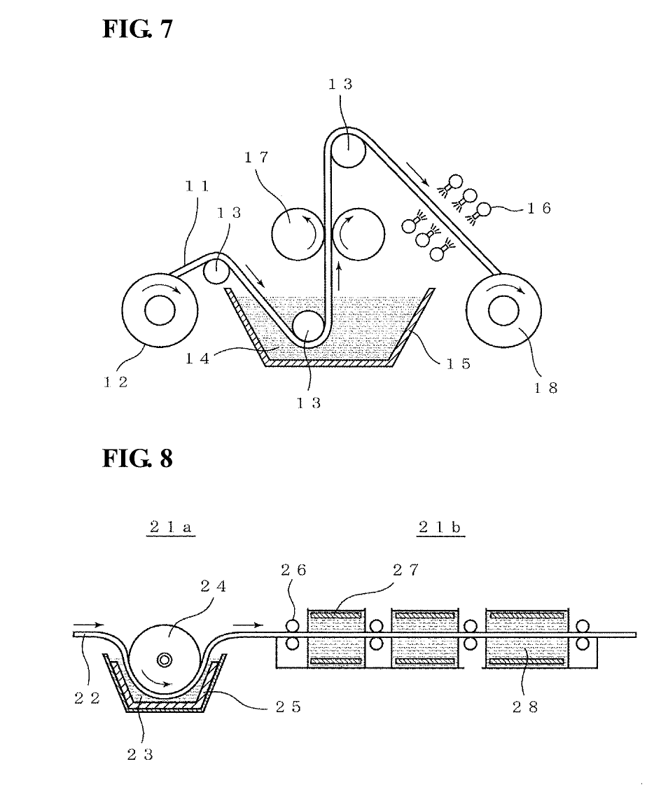

Carbon particles can be coated onto the resinous molded body by immersing the resinous molded body to be treated into the above-described suspension and then by performing squeezing and drying. In showing an example of a practical production process, FIG. 7 is a diagram schematically showing an example of the constitution of a treating apparatus for giving conductivity to a strip-shaped resinous molded body to be used as the skeleton. As shown in FIG. 7, this apparatus is provided with a supply bobbin 12 for supplying a strip-shaped resin 11, a bath 15 housing a suspension 14 of conducting paint, a pair of squeezing rollers 17 placed above the bath 15, a plurality of hot-air nozzles 16 oppositely placed at the sides of the running strip-shaped resin 11, and a take-up bobbin 18 for taking up the treated strip-shaped resin 11. In addition, deflecting rollers 13 for guiding the strip-shaped resin 11 are placed as appropriate. In the apparatus having the constitution as described above, the strip-shaped resin 11 having the three-dimensional network structure is rewound from the supply bobbin 12, guided by a deflecting roller 13, and immersed into the suspension in the bath 15. The strip-shaped resin 11 having been immersed in the suspension 14 in the bath 15 changes its direction upward and runs between the squeezing rollers 17 placed above the liquid surface of the suspension 14. In this case, because the gap between the squeezing rollers 17 is set to be smaller than the thickness of the strip-shaped resin 11, the strip-shaped resin 11 is compressed. As a result, an excessive liquid of the suspension remaining in the strip-shaped resin 11 is squeezed out to return into the bath 15.

In succession, the strip-shaped resin 11 changes its running direction again. Then, the dispersion medium and the like in the suspension are removed by the hot air injected from the multiple hot-air nozzles 16. After being sufficiently dried, the strip-shaped resin 11 is taken up by the take-up bobbin 18. It is desirable that the hot air injected from the hot-air nozzles 16 is held at a temperature in the range of 40° C. to 80° C. When the above-described apparatus is used, the conductivity-giving treatment can be performed automatically and continuously. Because this apparatus can form the skeleton that has a network structure free from clogging and a uniform conducting layer, the metal plating in the next step can be conducted smoothly.

### Formation of Aluminum Layer: Molten-Salt Plating

Subsequently, electrolytic plating is performed in a molten salt to form an aluminum plating layer on the surface of the resinous molded body. The cathode is formed by the resinous molded body whose surface has conductivity, the anode is formed by an aluminum plate having a purity of 99.99%, and DC current is supplied in a molten salt. As the molten salt, a mixed salt (a eutectic salt) of aluminum chloride and an organic salt is used. It is desirable to use an organic molten-salt bath that melts at relatively low temperatures because the plating can be performed without decomposing the resinous molded body used as the base material. As the organic salt, an imidazolium salt, a pyridinium salt, or the like can be used. Among these, it is desirable to use 1-ethyl-3-methylimidazolium chloride (EMIC) and butylpyridinium chloride (BPC).

To decrease the viscosity of the molten salt, the temperature of the molten-salt bath is set to be 40° C. or higher and 100° C. or lower. If the temperature is lower than 40° C., the viscosity cannot be decreased sufficiently. If the temperature is higher than 100° C., the organic salt may be decomposed. The more desirable temperature is 50° C. or higher and 80° C. or lower. It is desirable to perform the plating in an atmosphere of inert gas such as nitrogen or argon and in an enclosed environment because when water or oxygen intrudes into the molten salt, it deteriorates.

It is desirable to add 1,10-phenanthroline to the molten-salt bath because the surface becomes smooth and a nearly spherical portion can be formed at the end portion of the skeleton structure. It is desirable that the amount of addition of 1,10-phenanthroline be 0.25 g/l or more and 7 g/l or less. As the amount of addition increases, the end portion tends to become round. If the amount of addition is less than 0.25 g/l, it is difficult to achieve the effect of effectively forming the nearly spherical portion at the end portion of the skeleton structure and the effect of smoothing the surface of the skeleton structure. Although the increase in the amount of addition of 1,10-phenanthroline increases the effect of forming the nearly spherical portion and the effect of surface smoothing, an increase beyond 7 g/l cannot achieve a noticeable change in the effect. The more desirable range in the amount of addition is 2.5 g/l or more and 5 g/ or less.

When a method in which the viscosity is decreased by adding an organic solvent or the like into the molten-salt bath is employed for performing the plating, it is difficult to form the nearly spherical portion at the end portion of the skeleton structure. In addition, this method requires an apparatus for preventing the volatilization of the organic solvent and a safety apparatus for preventing the catching of fire caused by the organic solvent. In contrast, when the molten-salt bath added with phenanthroline is employed, the nearly spherical portion can be formed easily at the end portion of the skeleton structure. In the above description, the term “a nearly spherical portion” is intended to include, in addition to a portion having a perfectly spherical shape, a portion having a part of a spherical shape such as a hemispherical shape. At the central portion of the skeleton structure, the metal layer has the shape of a hollow cylinder. At the end portion of the skeleton structure, the nearly spherical portion is formed so as to close the end of the hollow cylinder. It is desirable that the nearly spherical portion have a diameter larger than the outer diameter of the skeleton structure. More specifically, it is desirable that the nearly spherical portion have a diameter of 20 μm or more and 50 μm or less, more desirably 30 μm or more and 40 μm or less.

FIG. 8 is a diagram schematically showing the structure of an apparatus for continuously performing metal-plating treatment on the above-described strip-shaped resin. FIG. 8 shows the structure in which a strip-shaped resin 22 whose surface has conductivity is advanced from the left to the right in the diagram. A first plating bath 21a has a cylindrical electrode 24, an anode 25 provided on the inner wall of a container, and a plating bath 23. The strip-shaped resin 22 passes through the plating bath 23 along the cylindrical electrode 24. Consequently, a uniform current flows easily throughout the resinous molded body, so that uniform plating can be achieved. A second plating bath 21b is a bath for augmenting the plating with a uniform thickness and is structured such that plating is repeated through a plurality of baths. An electrode roller 26, which combines an advancing roller and a current-feeding cathode outside the bath, continuously advances the strip-shaped resin 22, whose surface has conductivity, to cause the resin to pass through a plating bath 28, so that the plating is performed. At the inside of each of the multiple baths, an anode 27 is provided at both sides of the resinous molded body so as to be separated by the plating bath 28. This structure can perform more uniform plating from both sides of the resinous molded body.

The above-described steps can produce a porous aluminum body having a resinous molded body as the core of the skeleton structure. Depending on the applications such as various filters and a catalyst carrier, the porous aluminum body may be used as a composite of resin and metal. When used as a porous metal body having no resin because of the restriction by the usage environment, the resin may be removed. The resin can be removed by any method such as decomposition (dissolution) by using an organic solvent, a molten salt, or supercritical water and thermolysis. Unlike nickel or the like, aluminum is difficult to reduction-treat once it is oxidized. Consequently, when it is used, for example, as an electrode material for a battery or the like, it is desirable to remove the resin through a method that is less likely to oxidize aluminum. For example, it is desirable to use a method that removes the resin by thermolysis in a molten salt as explained below.

### Removal of Resin: Thermolysis in Molten Salt

The thermolysis in a molten salt is performed by using the method described below. A resinous molded body whose surface has an aluminum plating layer is immersed in a molten salt, and while a negative potential is being applied to the aluminum layer, the heating of the resinous molded body is performed to decompose it. When a negative potential is applied under the condition of immersion in a molten salt, the resinous molded body can be decomposed without oxidizing the aluminum. The heating temperature can be selected as appropriate in accordance with the type of resinous molded body. Nevertheless, in order not to melt the aluminum, it is necessary to conduct the treatment at a temperature at most the melting point of aluminum (660° C.). The desirable temperature range is 500° C. or higher and 600° C. or lower. The value of the negative potential to be applied is specified to be at the negative side relative to the reducing potential of aluminum and at the positive side relative to the reducing potential of a cation in a molten salt.

As the molten salt to be used in thermolysis of the resin, a salt of a halogenide of alkali metal or alkaline earth metal both of which cause the electrode potential of aluminum to be base or a nitrate can be used. More specifically, it is desirable that the molten salt contain at least one member selected from the group consisting of lithium chloride (LiCl), potassium chloride (KCl), sodium chloride (NaCl), aluminum chloride (AlCl₃), lithium nitrate (LiNo₃), lithium nitrite (LiNo₂), potassium nitrate (KNo₃), potassium nitrite (KNo₂), sodium nitrate (NaNo₃), and sodium nitrite (NaN₂). The above-described method enables the production of a porous aluminum body whose oxide layer on the surface is thin and low in oxygen content.

### Lithium-Ion Battery

Next, an explanation is given to an electrode material for batteries and a battery both incorporating the porous aluminum body. For example, when the porous aluminum body is used as the positive electrode of a lithium-ion battery, as the active material, lithium cobalt oxide (LiCoO₂), lithium manganate (LiMn₂O₄), lithium nickel oxide (LiNiO₂), or the like is used. The active material is used in combination with a conductive aid and a binder. In the conventional positive-electrode material for a lithium-ion battery, an active material is coated on the surface of an aluminum foil. To increase the battery capacity per unit area, the coating thickness of the active material is increased. To effectively utilize the active material, it is necessary to bring the aluminum foil into electrical contact with the active material. For this reason, the active material is used by mixing with a conductive aid.

The porous aluminum body of the present invention has a high porosity and a large surface area per unit area. Consequently, even when a thin layer of active material is carried on the surface of the porous body, the active material can be utilized effectively, so that not only can the capacity of the battery be increased but also the mixing amount of the conductive aid can be decreased. More specifically, first, a sheet-shaped porous aluminum body having a thickness of 1,000 μm or more and 3,000 μm or less is prepared. Second, a paste formed by mixing the above-described active material with a conductive aid, a binder resin, and the like is coated on the porous aluminum body. This operation causes the porous aluminum body to carry the active material and thus forms the positive electrode of a lithium-ion battery. A lithium-ion battery uses this positive-electrode material as the positive electrode, graphite as the negative electrode, and an organic electrolytic solution as the electrolyte. The above-described lithium-ion battery can increase the capacity even with a small electrode area, so that the battery can have a higher energy density than that of the conventional lithium-ion battery.

### Molten-Salt Battery

The porous aluminum body can also be used as an electrode material for a molten-salt battery. When the porous aluminum body is used as the positive-electrode material, as the active material, sodium chromate (NaCrO₂), titanium disulfide (TiS₂), or another metallic compound that can perform intercalation of a cation of a molten salt used as an electrolyte is used. The active material is used in combination with a conductive aid and a binder. As the conductive aid, acetylene black or the like can be used. As the binder, polytetrafluoroethylene (PTFE) or the like can be used. When sodium chromate is used as the active material and acetylene black is used as the conductive aid, PTFE is desirable because it can more firmly bind the two materials with each other.

The porous aluminum body can also be used as a negative-electrode material for a molten-salt battery. When the porous aluminum body is used as the negative-electrode material, as the active material, a simple substance of sodium, an alloy of sodium and another metal, carbon, and the like can be used. Because sodium has a melting point of about 98° C. and temperature increase softens metal, it is desirable to form an alloy of sodium and another metal such as Si, Sn, or In. Of these, in particular, an alloy of sodium and Sn is easy to handle and hence desirable. Sodium or a sodium alloy can be carried on the surface of the porous aluminum body through electrolytic plating, hot dipping, or another method. Alternatively, after a metal, such as Si, to be alloyed with sodium is adhered on the porous aluminum body through plating or another method, the charging in a molten-salt battery can also form a sodium alloy.

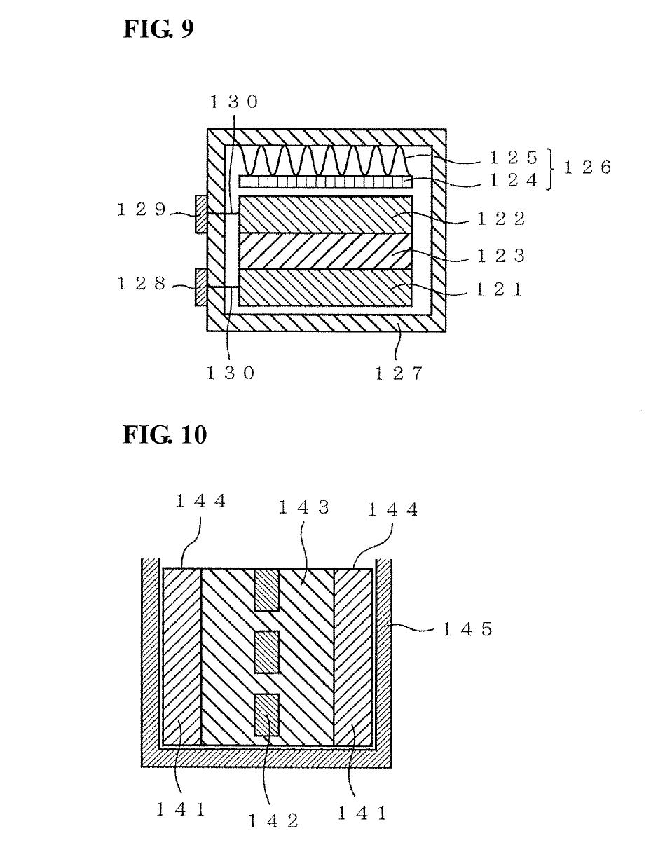

FIG. 9 is a schematic cross-sectional view showing an example of a molten-salt battery incorporating the above-described electrode material for batteries. The molten-salt battery has a structure in which a case 127 houses a positive electrode 121 carrying an active material for a positive electrode on the surface of the aluminum skeleton portion of the porous aluminum body, a negative electrode 122 carrying an active material for a negative electrode on the surface of the aluminum skeleton portion of the porous aluminum body, and a separator 123 impregnated with a molten salt used as an electrolyte. A pressing member 126, which has a pressing plate 124 and a spring 125 that presses the pressing plate, is placed between the upper plate of the case 127 and the negative electrode. Even when volume variation occurs in the positive electrode 121, the negative electrode 122, and the separator 123, the providing of the pressing member can bring the individual members into contact with each other by pressing them uniformly. The collector (a porous aluminum body) of the positive electrode 121 and the collector (a porous aluminum body) of the negative electrode 122 are connected to a positive-electrode terminal 128 and a negative-electrode terminal 129, respectively, through a lead 130.

As the molten salt as the electrolyte, various inorganic or organic salts that melt at the operating temperature can be used. As the cation of the molten salt, at least one member selected from the group consisting of alkali metals such as lithium (Li), sodium (Na), potassium (K), rubidium (Rb), and cesium (Cs) and alkaline earth metals such as beryllium (Be), magnesium (Mg), calcium (Ca), strontium (Sr), and barium (Ba) can be used.

To decrease the melting point of the molten salt, it is desirable to use at least two types of salts by mixing them. For example, when KFSA (potassium bis(fluorosulfonyl)amide) and NaFSA (sodium bis(fluorosulfonyl)amide) are used in combination, the operating temperature of the battery can become 90° C. or below.

The molten salt is used in the form of impregnation of the separator with it. The separator is used to prevent the positive electrode from making contact with the negative electrode, and glass nonwoven fabric, a porous resinous molded body, and the like can be used as the separator. The above-described positive electrode, negative electrode, and separator impregnated with a molten salt are stacked on top of each other, and they are housed in a case to be used as a battery.

### Electric Double-Layer Capacitor

The porous aluminum body can also be used as an electrode material for an electric double-layer capacitor. When the porous aluminum body is used as the electrode material for an electric double-layer capacitor, as the electrode active material, activated carbon or the like is used. The activated carbon is used in combination with a conductive aid and a binder. As the conductive aid, graphite, a carbon nanotube, or the like can be used. As the binder, polytetrafluoroethylene (PTFE), styrene-butadiene rubber, or the like can be used.

FIG. 10 is a schematic cross-sectional view showing an example of an electric double-layer capacitor incorporating the above-described electrode material for an electric double-layer capacitor. Electrode materials each carrying an electrode active material on the porous aluminum body are placed as polarizable electrodes 141 in an organic electrolytic solution 143 separated by separators 142. The polarizable electrodes 141 are connected with leads 144. All of these components are housed in a case 145. The use of the porous aluminum body as the collector increases the surface area of the collector. In consequence, even when the activated carbon as the active material is coated as a thin layer, an electric double-layer capacitor capable of increasing the output and capacity can be obtained.

### Example 1

### Formation of Conducting Layer: Coating of Carbon

An example of production of a porous aluminum body is concretely explained below. As a resinous molded body having a three-dimensional network structure, a urethane foam having a thickness of 1 mm, a porosity of 95%, and a pore diameter of 300 μm was prepared and cut to pieces of 80 mm by 50 mm. The urethane foam was immersed in a carbon suspension and then dried to form a conducting layer composed of carbon particles adhering to the entire surface. The suspension had 25% of graphite and carbon black together, a resinous binder, a penetrant, and an antifoamer. The carbon black had a particle diameter of 0.5 μm.

### Molten-Salt Plating

A urethane foam having a conducting layer on its surface was used as a workpiece. A workpiece was set on a jig having a current-feeding function. The workpiece was placed in a glove box having an argon atmosphere of low moisture content (dew point: −30° C. or below) to be immersed in a molten-salt bath (33 mol % EMIC-67 mol % AlCl₃) having added 5 g/l phenanthroline. The jig, to which the workpiece was set, was connected to the negative electrode of the rectifier, and an aluminum plate (purity: 99.99%) placed as the opposite electrode was connected to the positive electrode. Then, a DC current was supplied to perform aluminum plating. The plating bath was held at a temperature of 60° C.

### Decomposition of Resinous Molded Body

The individual resinous molded body having an aluminum plating layer was immersed in an LiCl—KCl eutectic molten salt at a temperature of 500° C. A negative potential of −1 V was applied to the body for five minutes to decompose and remove the polyurethane. Thus, a porous aluminum body was obtained. FIG. 11 shows an enlarged surface photograph of the obtained porous aluminum body.

### Example 2

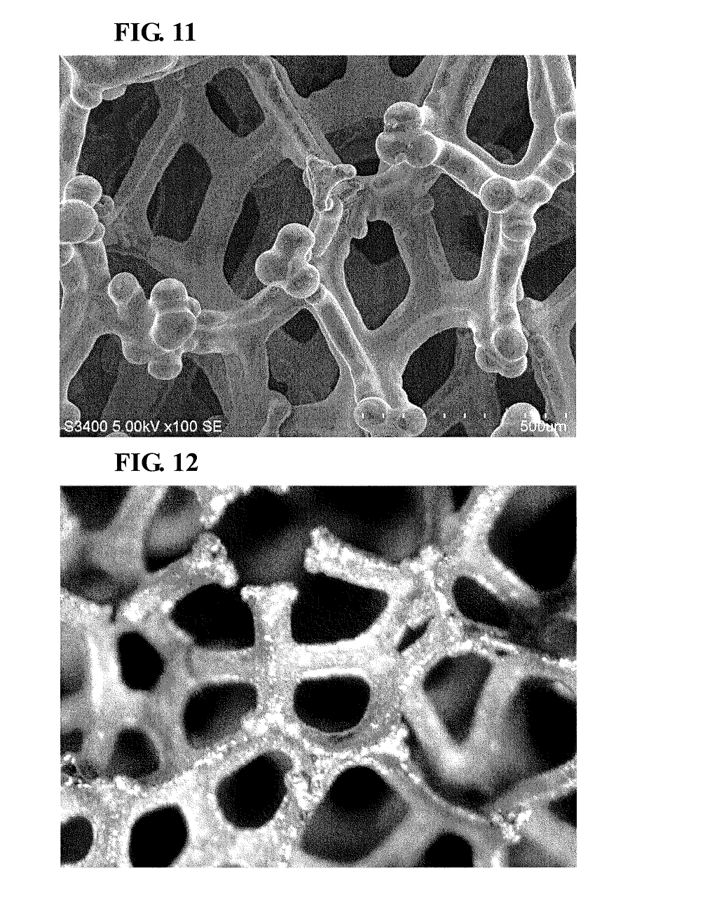

A porous aluminum body was obtained by conducting the same operation as that in Example 1 except that the plating bath had a phenanthroline concentration of 0.25 g/l. FIG. 12 shows an enlarged surface photograph of the obtained porous aluminum body.

### Comparative Example 1

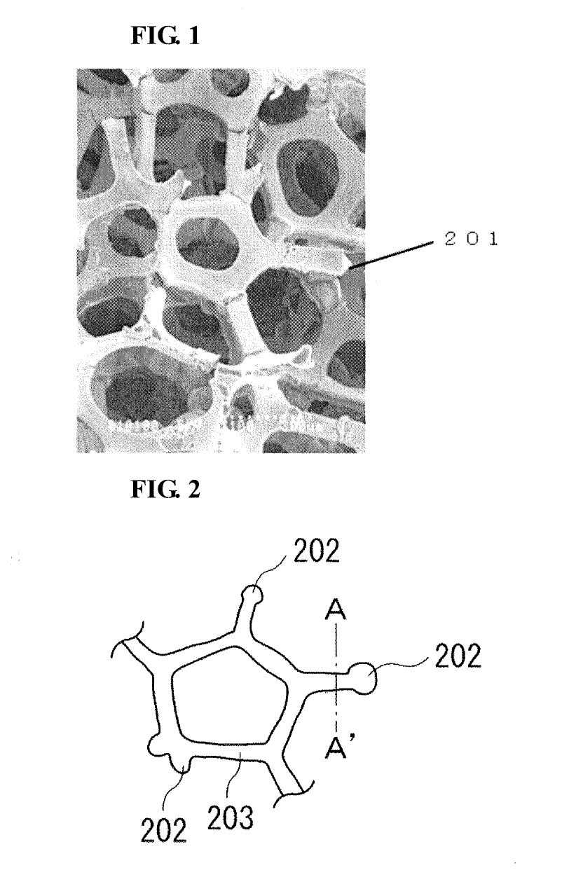

A porous aluminum body was obtained by conducting the same operation as that in Example 1 except that 17 mol % EMIC-34 mol % AlCl₃-49 mol % xylene was used as the plating bath and the plating bath was held at a temperature of 40° C. FIG. 1 shows an enlarged surface photograph of the obtained porous aluminum body.

As shown in FIG. 11, the porous aluminum body in Example 1, in which the plating bath has a phenanthroline concentration of 5 g/l, has end portions where nearly spherical portions are formed, and the nearly spherical portions each have a diameter larger than that of the skeleton portion. As shown in FIG. 12, although the porous aluminum body in Example 2, in which the phenanthroline concentration is 0.25 g/l, has end portions where nearly spherical portions are formed, the nearly spherical portions each have a diameter smaller than that of the skeleton portion. The porous aluminum body in Comparative example, in which the plating is performed without adding phenanthroline but by adding an organic solvent (xylene), has end portions where nearly spherical portions are not formed, and consequently it seems that the strength at the end portions of the skeleton structure is weakened.

### REFERENCE SIGNS LIST

1: Foamed resinous molded body; 2: Conducting layer; 3: Aluminum plating layer;

11: Strip-shaped resin; 12: Supply bobbin; 13: Deflecting roller; 14: Suspension;

15: Bath; 16: Hot-air nozzle; 17: Squeezing roller; 18: Take-up bobbin;

21a and 21b: Plating bath; 22: Strip-shaped resin; 23 and 28: Plating bath;

24: Cylindrical electrode; 25 and 27: Anode; 26: Electrode roller;

121: Positive electrode; 122: Negative electrode; 123: Separator; 124: Pressing plate;

125: Spring; 126: Pressing member; 127: Case; 128: Positive-electrode terminal;

129: Negative-electrode terminal; 130: Lead;

141: Polarizable electrode; 142: Separator; 143: Organic electrolytic solution;

144: Lead; 145: Case;

201: Edge portion; 202: Nearly spherical portion; 203: Skeleton structure.

1. A porous metal body, comprising a skeleton structure that is formed of a metal layer, that has a three-dimensional network structure, and that has an end portion provided with a nearly spherical portion.

2. The porous metal body as defined by claim 1, wherein the metal is aluminum.

3. The porous metal body as defined by claim 1, wherein the nearly spherical portion has a diameter larger than an outer diameter of the skeleton structure.

4. The porous metal body as defined by claim 1, wherein the skeleton structure has a cross section of a nearly triangular shape, the triangular shape has an outer diameter of 100 μm or more and 250 μm or less, and the metal layer has a thickness of 0.5 μm or more and 10 μm or less.

5. The porous metal body as defined by claim 1, having the shape of a sheet that has a thickness of 1,000 μm or more and 3,000 μm or less;
wherein at the thickness of 1,000 μm, the quantity of aluminum per unit area is 120 g/m² or more and 180 g/m² or less.

6. An electrode material, comprising the porous metal body as defined by claim 1 that carries an active material.

7. A battery, comprising the electrode material as defined by claim 6 that is used as a positive electrode, a negative electrode, or both.

8. A method of producing the porous metal body as defined by claim 2, comprising a step of plating a resinous molded body, having a three-dimensional network structure in which at least the surface has conductivity, with aluminum in a molten-salt bath that contains 1,10-phenanthroline at a concentration of 0.1 g/l or more and 10 g/l or less and that is held at a temperature of 40° C. or higher and 100° C. or lower.
